(19) United States
(12) Patent Application Publication
(10) Pub. No.: US 2018/0039704 A1
(43) Pub. Date: Feb. 8, 2018

(54) AN ONLINE FORUM TOOL

(71) Applicant: Azure 101 Pty Ltd, Minyama, QLD (AU)

(72) Inventors: Christopher James CHAMBERS, Queensland (AU); Michael Andrew NEVILLE, Queensland (AU)

(21) Appl. No.: 15/547,397

(22) PCT Filed: Jan. 29, 2016
(86) PCT No.: PCT/AU2016/050048

§ 371 Date: Jul. 28, 2017

(30) Foreign Application Priority Data
Jan. 29, 2015 (AU) 2015900250
Feb. 3, 2015 (AU) 2015900321

(51) Int. Cl. G06F 17/30; G06Q 10/10

(52) U.S. Cl. CPC G06F 17/30867; G06F 17/30876; G06Q 10/10

(57) ABSTRACT

The present invention relates to an online forum tool for following posts relating to topics of interest. The tool includes a topic display index for displaying post topics of interest to be possibly followed. A selection tool is provided for selecting one or more of the topics displayed in the topic display index. A following tool is provided for following posts relating to the topics selected using the selection tool. The following tool enables a user to follow relevant posts relating to the selected topics of interest from the index to thereby maintain the user's interest. The following tool may include one or more feature groups being followed, each feature group including topics of interest customized by the user using the selection tool. Advantageously, the user can use the single forum tool to follow posts relating to the various customized feature groups being followed.

### TECHNICAL FIELD

The present invention generally relates to online forums.

### BACKGROUND

The reference to any prior art in this specification is not, and should not be taken as an acknowledgement or any form of suggestion that the prior art forms part of the common general knowledge.

Online forums enable users to place posts and review other user's posts in relation to topics of interest. For example, a user that is interested in cars can become a member of a car forum, and participate in the forum by placing and reviewing posts relating to cars.

In practice, the applicant has perceived that many of the numerous posts in a particular forum are of no particular interest to the user, who often then becomes disinterested.

It is an object of the present invention to better maintain the online forum user's interest.

Furthermore, forum users are often interested in many topics and are therefore members of several different forums. The applicant has perceived that it can be unwieldy and cumbersome to navigate between several forums and manage several different memberships. There is a need for providing improved co-ordination of several topics at once.

### SUMMARY OF THE INVENTION

According to one aspect of the present invention, there is provided an online forum tool for following posts relating to topics of interest, the tool including:

a topic display index for displaying forum topics of interest to be possibly followed;

a selection tool for selecting one or more of the topics displayed in the topic display index; and

a following tool for following posts relating to the topics selected using the selection tool.

Advantageously, the following tool enables a user to follow relevant posts relating to the customized topics of interest that were selected, thereby maintaining the user's interest. Preferably, many forums are located in one tool/product that requires a single sign-on.

The following tool may include one or more feature groups being followed, each feature group including topics of interest customized by the user using the selection tool. Advantageously, the user can use the single forum tool to follow posts relating to the various customized feature groups being followed. The feature groups may be displayed in a topic group display.

The forum tool may further include a display tool for displaying the followed posts relating to different topics. The display tool may include a category feed for chronologically displaying the followed posts. The display tool may further include an author feed for chronologically displaying posts from authors being followed which effectively represents a further refinement and filtering of posts from the category feed. The forum tool may include an author selection tool for selecting authors to be added to the author feed from the category feed. The display tool may further include end buttons for navigating to respective ends of the category feed.

The selection tool may form at least one feature group including topics of interest selected from the display index. The feature group may include a target and the selected topics may be dragged and dropped onto the target. Each topic may include a select toggle actuator for selecting or deselecting the topic from the feature group. The selection tool may include an index addition tool for adding the feature group to the index.

The topic display index may include hierarchically arranged selectable lists of topics which advantageously facilitate levels of customization to suit the user. The topic display index may be arranged in alphabetical order. The index may include a selectable alphabet menu. The index may include topic lists. A topic may be associated with one or more actuators to assist in creating a feature group of the selection tool and adding topics to the feature group.

According to another aspect of the present invention, there is provided an online forum topic following method for following posts relating to topics of interest, the method including:

displaying post topics of interest to be possibly followed;

selecting one or more of the displayed topics; and

following posts relating to the selected topics.

The method may further involve adding the selected topics to a feature group. The step of following may involve adding the feature group to a following tool so as to follow posts relating to the selected topics in the feature group.

The method may further involve using a single forum tool to follow posts relating to various customized feature groups being followed. The method may further involve following both: a category feed chronologically displaying the followed posts; and an author feed chronologically displaying posts from authors being followed which effectively represents a further refinement and filtering of posts from the category feed. The method may further involve selecting topics and subtopics from an index including hierarchically arranged selectable lists to facilitate levels of post customization.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic view of a webpage of an online forum tool in accordance with an embodiment of the present invention, the webpage displaying a single category feed of related posts depending upon whether the cars feature group or beekeeping topic is selected;

FIG. 2 is a schematic view of a topic customization webpage of the online forum tool of FIG. 1;

FIG. 3 is a flowchart of a topic following method performed using the online forum tool shown in FIGS. 1 and 2;

FIG. 4 shows a topic display index including several hierarchical layers of topic lists;

FIG. 5 is a schematic view of a webpage of an online forum tool, the webpage displaying a single category feed relating to the cars feature group and beekeeping topic being followed; and

FIG. 6 is a schematic view of a webpage of an online forum tool, the webpage displaying a single category feed for the cars feature group which, in turn, includes the beekeeping topic.

### DETAILED DESCRIPTION OF PREFERRED EMBODIMENTS

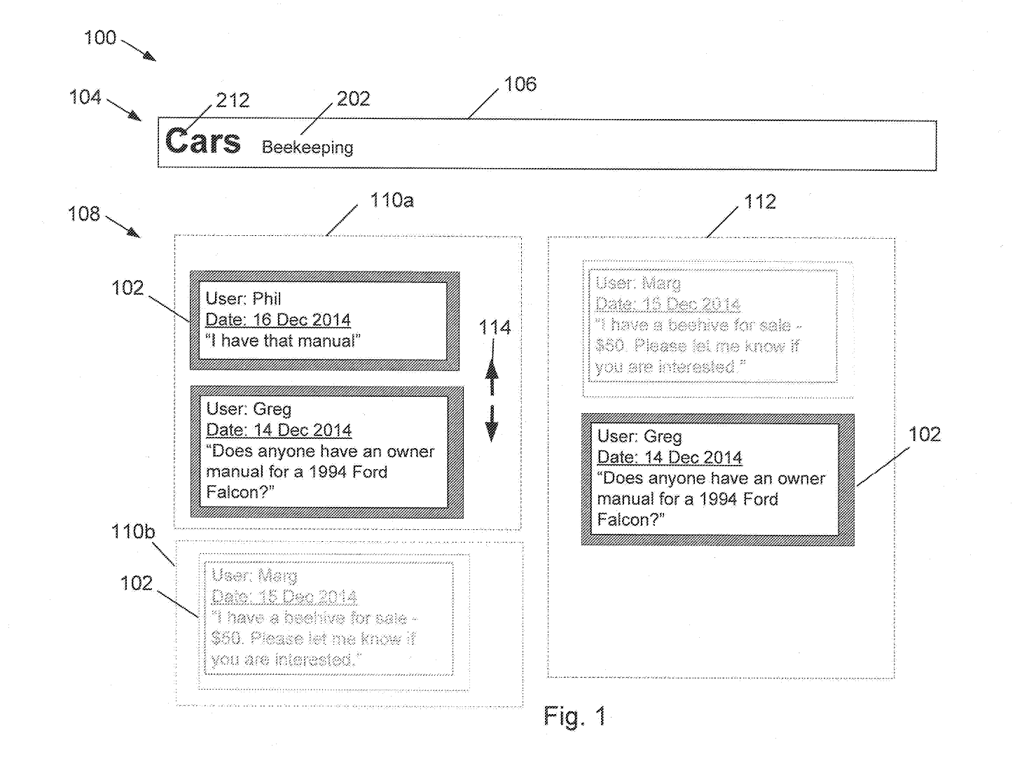

According to an embodiment of the present invention, there is provided an online forum website (i.e. tool) 100 for following user posts 102 as shown in FIG. 1. The forum posts 100 relate to forum topics (e.g. cars, bee keeping, ballooning, etc.) that are of particular interest to a website user and member. Many forums are located in one website tool/product that conveniently only requires a single user sign-on.

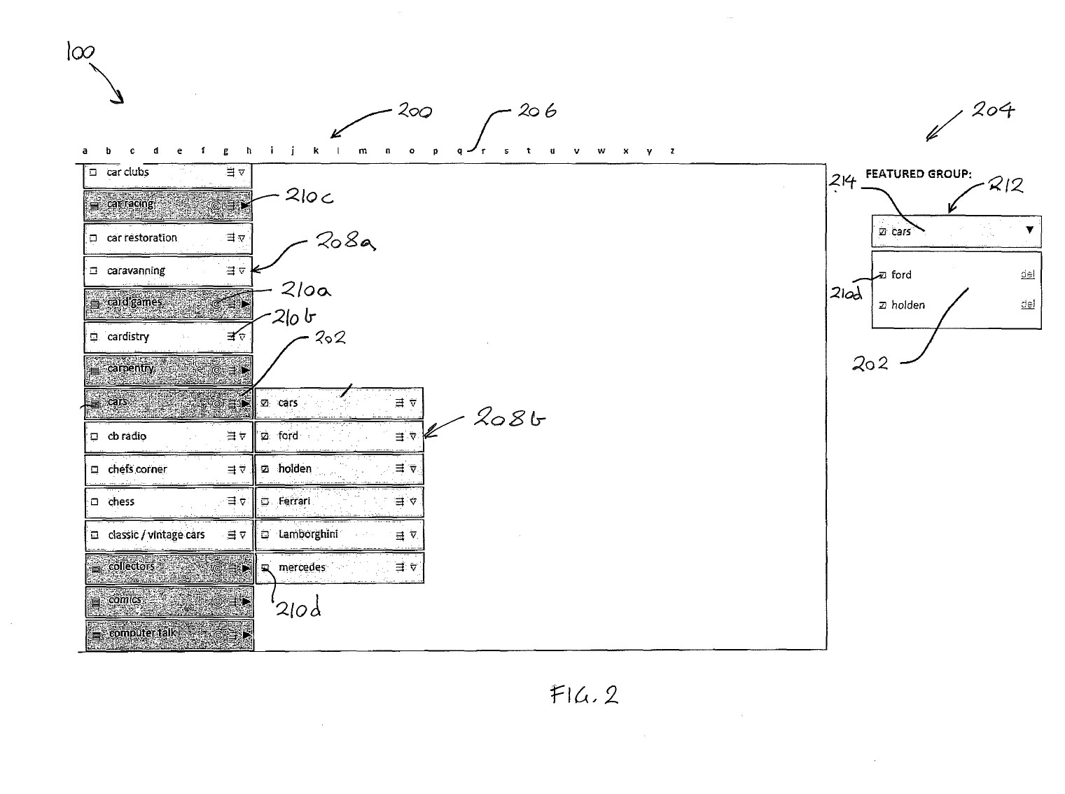

Turning to FIG. 2, the website 100 includes a topic display index 200 for displaying post topics 202 of interest to be possibly followed by the user. A selection tool 204 is provided for enabling the user to select one or more of the displayed topics 202.

Returning to FIG. 1, the website 100 includes a following tool 104 for only following posts 102 relating to the topics selected using the selection tool 204 and from the index 200. Advantageously, the following tool 104 enables the user to follow relevant posts 102 relating to the customized topics of interest that were selected, thereby maintaining the user's interest and better enabling the user to manage topic posts 102. The website 100 is described in detail below.

Returning to FIG. 2, the topic display index 200 is selectable and arranged in alphabetical order. The index 200 includes a selectable alphabet menu 206 including each letter of the alphabet and a searchable alphabet field with auto-population capabilities. The index 200 further includes parent topic list 208a and child topic list 208b, which are hierarchically arranged to advantageously facilitate post customization to suit the user. In practice, selection of a letter of the alphabet (e.g. “c”) from the alphabet menu 206 will cause an associated parent topic list 208a, including topics 202 starting with the selected alphabet letter, to be displayed.

Each topic 202 is associated with up to four actuators 210a,b,c,d to assist in creating a feature group 212 with the selection tool 204, and adding topics 202 to that feature group 212. The actuators 210a,b,c,d are a select all actuator 210a for selecting all topics 202 in the child topic list 208b to be later added to the feature group 212; a feature group actuator 210b for generating the feature group 212 including selected topics 202; a child display actuator 210c for displaying more refined child topics in the child topic list 208b; and a select toggle actuator 210d for selecting or deselecting the topic 202 from the feature group 204 or topic group display 106.

The selection tool 204 includes the feature group 212 (e.g. cars) having a header 214 and a list of associated selected topics 202 (e.g. ford and holden). The feature group 204 includes a blank target, and the selected topics in the index 200 can be dragged and dropped onto the target. Each topic 202 in the feature group 212 also includes a select toggle actuator 210d for selecting or deselecting the topic 202 from the feature group 212.

Returning to FIG. 1, the following tool 104 includes a topic group display 106 for displaying feature groups 212 being followed (e.g. cars) as well as any direct topics 202 (e.g. beekeeping) which are of interest. Each followed feature group 212 includes topics 202 previously customized by the user using the selection tool 204. Advantageously, the user can use the single website 100 to follow posts 102 relating to the various customized feature groups 212 being followed.

The forum website 100 further includes a display tool 108 for displaying the followed posts 102. Selection of a topic 202 or feature group 212 in topic group display 106 drives the display of corresponding posts 102 in related category feeds 110 or 112 of the display tool 108. For example, selecting the “Cars” feature group 212 displays posts 102 in a cars category feed 110a. The “Beekeeping” topic 202 is not selected, and therefore the related beekeeping category feed 110b is not displayed (i.e. ghosted in FIG. 1) and any related beekeeping posts 102 are also not displayed in an author feed 112. Conversely, selecting the Beekeeping topic 202 will display all (ghosted) posts 102 relating to beekeeping, and no posts 102 relating to cars will be displayed. The selected category feeds 110, 112 chronologically display the followed posts 102 corresponding to followed topics 202 or feature groups 212 as selected in display 106. For example, users Phil and Greg have posted posts 102 relating to the cars feature group 212, whereas user Marg has posted a post 102 relating to the bee keeping topic 202.

The display tool 108 further includes an author feed 112 for chronologically displaying posts 102 from authors being followed which effectively represents a further refinement and filtering of posts 102 from the category feed 110. In this manner, posts 102 from an author of interest are less likely to be overlooked by the user. The forum website 100 is configured so that users can select authors to be added to the author feed 112 from the category feed 110. In the present example, the user is following the authors Marg and Greg, but not Phil.

The display tool 108 further includes top and bottom end floating buttons 114 for navigating to respective ends of the category feed 110 in the event of many posts 102.

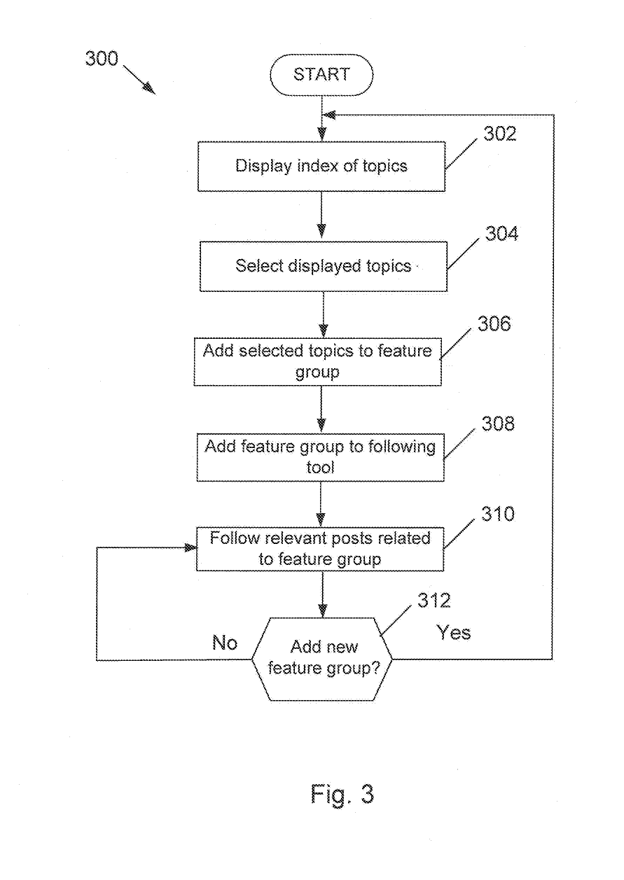

An online forum topic following method 300 for following posts 102 relating to topics 202 of interest to the website user is now described with reference to FIG. 3.

Initially, at step 302, the topic display index 200 is displayed to assist the user with selecting possible interesting topics 202 and subtopics as shown in FIG. 2, in any combination. Topics 202 from the index 200 can be directly added to the topic group display 106, or can be added to a customized feature group 212 in turn later added to the topic group display 106 as described below.

At step 304, one or more of the displayed topics 202 in the index 200 is selected by the user. The user can first select a letter of the alphabet (e.g. c) from the selectable alphabet menu 206 to bring up the parent topic list 208a. In turn, the user can view the child topic list 208b and select topics 202 using the actuators 210. The user can navigate through the index 200 selecting and deselecting topics 202 and subtopics from any parent or child lists 208.

At step 306, the selected topics 202 can be added to the feature group 212 via the selection tool 204 by the user. In particular, the selected topics 202 in the index 200 can be collectively dragged and dropped onto the target feature group 212 by the user.

At step 308, the completed feature group 212 (e.g. cars containing subtopics ford and holden) is added to the topic group display 106 of the following tool 104 by the user.

At step 310, the category feed 110 follows and displays relevant posts 102 relating to the selected topics in the feature groups 212 and topics 202 in the topic group display 106. The author feed 112 follows and displays relevant posts 102 for authors being followed.

At query step 312, the user can either return to step 302 to add further feature groups 212 to follow, or continue to follow fed posts 102 relating to the selected feature groups 212 at step 310. Feature groups 212 can also be conveniently removed at any time if they are no longer of interest to the user.

A person skilled in the art will appreciate that many embodiments and variations can be made without departing from the ambit of the present invention.

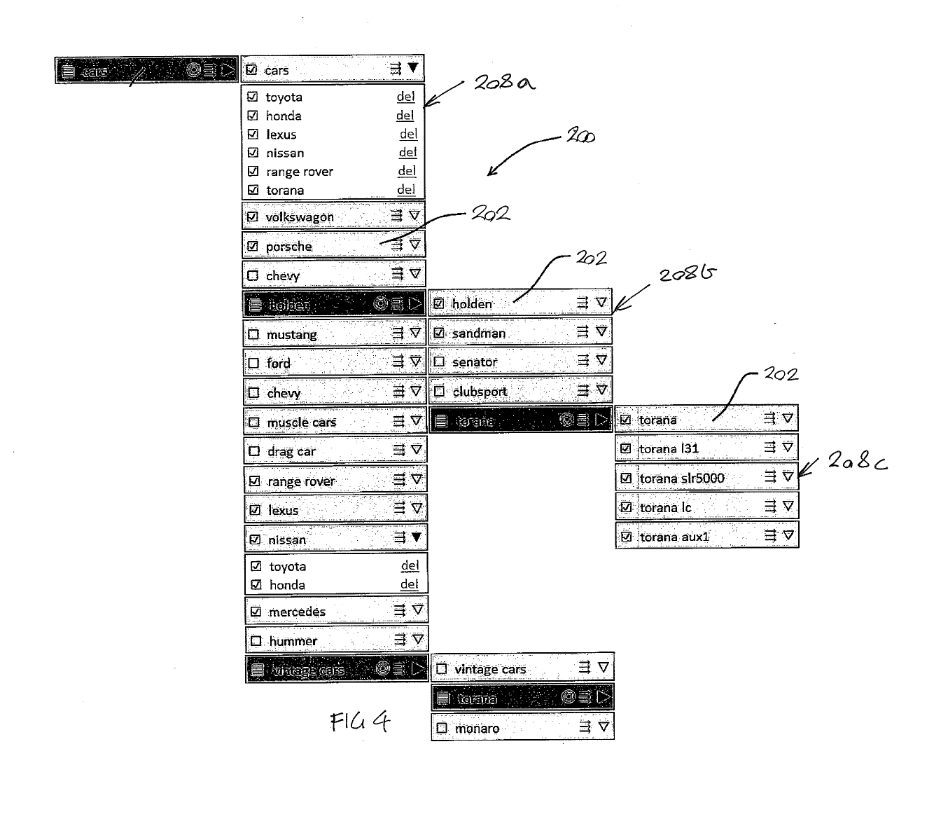

In one embodiment, the topic display index 200 may include several hierarchical layers of topic lists 208 as shown, for example, in FIG. 4 and for refining the feature groups 212 to display posts 102 of more relevance.

In one embodiment, the displayed posts 102 can only be viewed by members of a private group.

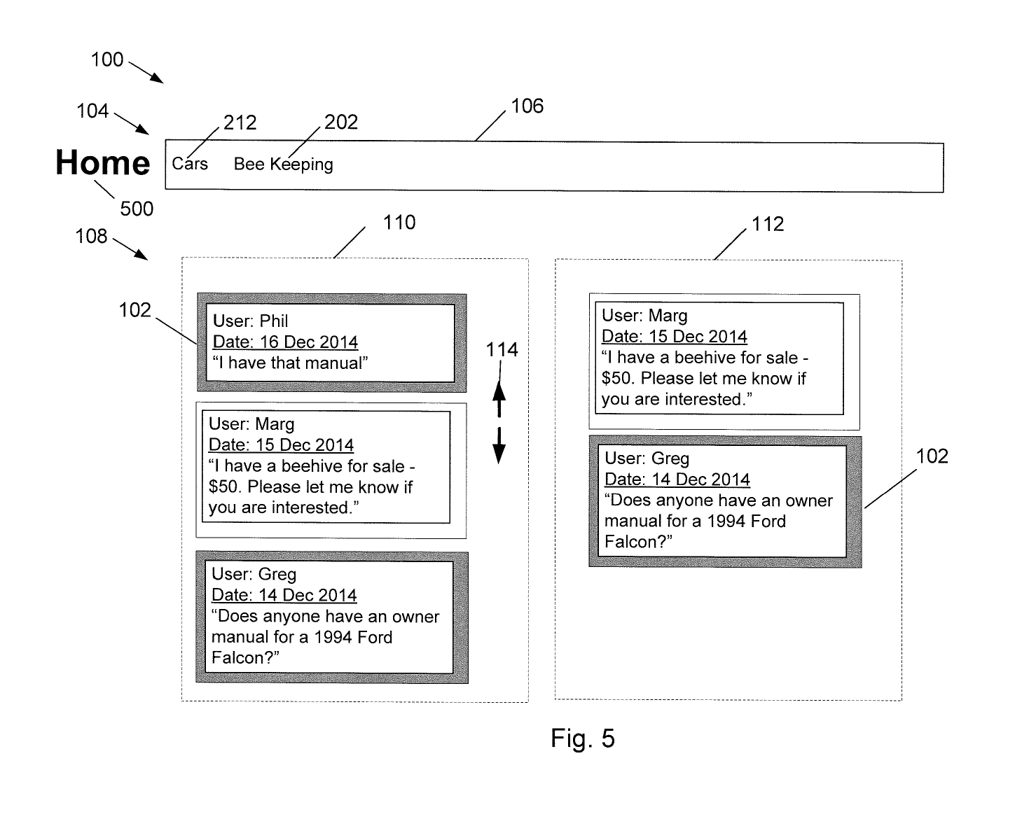

In one embodiment, all posts 102 relating to all feature groups 212 and topics 202 in topic group display 106 will be chronologically displayed in the same category feed 110 as shown in FIG. 5. The author feed 112 shows posts from the category feed 110 for authors being followed. The user can select the home button 500 to enable this show-all feature whereby all the relevant posts 102 are displayed in the two category feeds 110, 112.

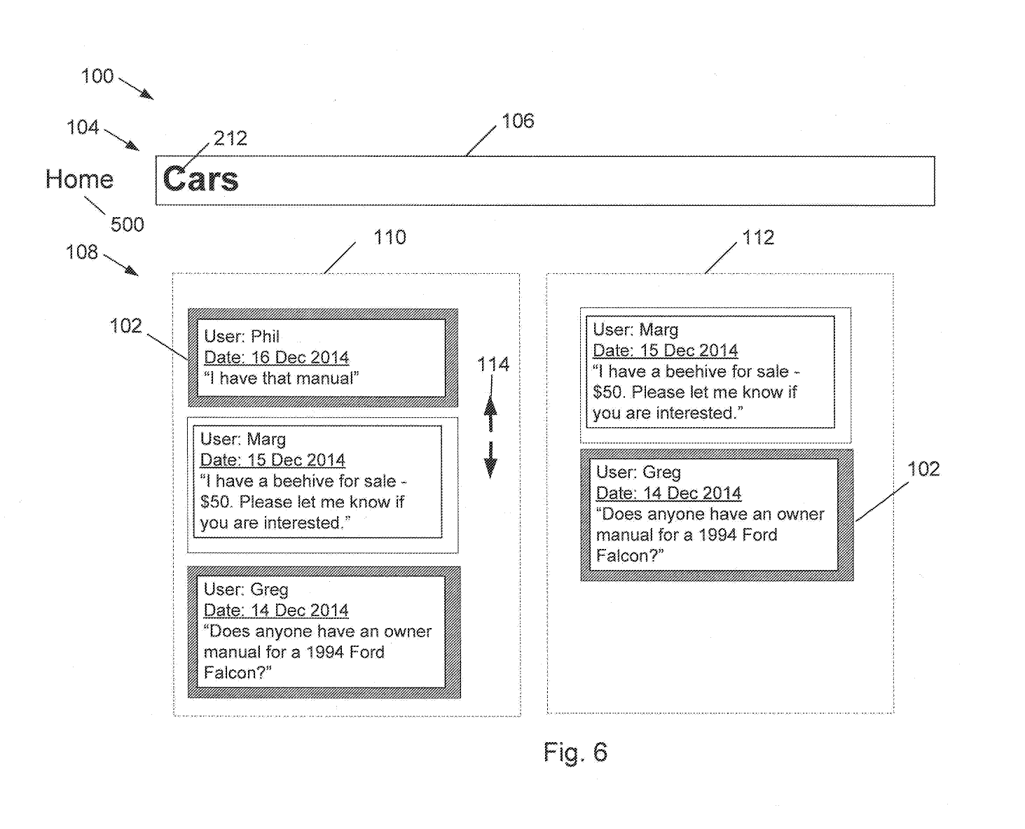

Turning to FIG. 6, the Beekeeping Topic 202 may be added to the Cars Feature Group 212 using the selection tool 204 as previously described in relation to FIG. 2. In this event, the user can select either the home button 500 or the “Cars” feature group 212 in display 106 to generate the same category feeds 110, 112 as shown in FIG. 5. The user can therefore highly customize any feature group 212 to display posts relating to any topics 202 of interest.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. An online forum tool for following posts relating to topics of interest, the tool including:
a hierarchical topic display index displaying a plurality of forum topics that are hierarchically arranged such that at least one of the plurality of forum topics defines a sub-topic of another forum topic, and wherein each of the plurality of forum topics is selectable to facilitate various levels of customization to suit the user;
a selection tool for selecting one or more of the forum topics displayed in the topic display index; and
a following tool for following posts relating to the forum topics selected using the selection tool, the following tool enabling a user to follow relevant posts relating to the selected forum topics from the topic display index to thereby maintain the user's interest.

2. An online forum tool as claimed in claim 1, wherein the following tool includes one or more feature groups being followed, each feature group including topics of interest customized by the user using the selection tool, the user able to use the single forum tool to follow posts relating to the various customized feature groups being followed individually.

3. An online forum tool as claimed in claim 1, wherein the forum tool further includes a display tool for displaying the followed posts relating to different topics, the display tool able to display customised feature groups created from the index and/or topics directly selected from the index.

4. An online forum tool as claimed in claim 3, wherein the display tool includes a category feed for chronologically displaying the followed posts, the category feed able to be customized to: display only posts relating to followed and selected feature groups or topics and/or display all posts relating to followed feature groups or topics.

5. An online forum tool as claimed in claim 4, wherein the display tool further include an author feed for chronologically displaying posts from authors being followed which effectively represents a further refinement and filtering of posts from the category feed.

6. An online forum tool as claimed in claim 5, wherein the forum tool includes an author selection tool for selecting authors to be added to the author feed from the category feed.

7. An online forum tool as claimed in claim 3, wherein the display tool further includes end buttons for navigating to respective ends of the category feed.

8. An online forum tool as claimed in claim 1, wherein the selection tool includes at least one feature group including topics of interest selected from the display index.

9. An online forum tool as claimed in claim 8, wherein the feature group includes a target and the selected topics can be dragged and dropped onto the target.

10. An online forum tool as claimed in claim 8, wherein each topic includes a select toggle actuator for selecting or deselecting the topic from the feature group.

11. An online forum tool as claimed in claim 8, wherein the selection tool includes an index addition tool for adding the feature group to the index.

12. (canceled)

13. An online forum tool as claimed in claim 1, wherein the topic display index is arranged in alphabetical order, and includes either a selectable alphabet menu with letters that can be selected to display associated topic lists or a searchable field with auto-population capabilities.

14. An online forum tool as claimed in claim 1, wherein each topic of the index is associated with one or more actuators to assist in creating a feature group using the selection tool or adding topics to the feature group.

15. An online forum topic following method for following posts relating to topics of interest, the method including:
displaying post topics in a hierarchical topic display index, including a plurality of forum topics that are hierarchically arranged such that at least one of the plurality of forum topics defines a sub-topic of another forum topic, and wherein each of the plurality of forum topics is selectable to facilitate various levels of customization to suit the user;
selecting one or more of the displayed topics; and
following posts relating to the selected topics.

16. A method as claimed in claim 15, further involving adding the selected topics to a feature group.

17. A method as claimed in claim 16, further involving adding the feature group to a following tool so as to follow posts relating to the selected topics in the feature group.

18. A method as claimed in claim 15, further involving using a single forum tool to follow posts relating to various customized feature groups or topics being followed.

19. A method as claimed in claim 15, further involving following both: a category feed chronologically displaying the followed posts; and an author feed chronologically displaying posts from authors being followed which effectively represents a further refinement and filtering of posts from the category feed.

20. A method as claimed in claim 15, further involving selecting topics and subtopics from an index including hierarchically arranged selectable lists to facilitate levels of post customization.
